(19) United States
(12) Patent Application Publication
(10) Pub. No.: US 2008/0152348 A1
(43) Pub. Date: Jun. 26, 2008

(54) IR RECEIVER AND IR TRANSMITTER/RECEIVER MODULE USING SAME

(75) Inventor: GA-LANE CHEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/687,156

(22) Filed: Mar. 16, 2007

(30) Foreign Application Priority Data
Dec. 20, 2006 (CN) 200610157704.5

(51) Int. Cl. H04B 10/00

(52) U.S. Cl. 398/130

(57) ABSTRACT

An exemplary IR receiver configured for capturing IR signals is provided. The IR receiver includes an aspherical lens, an IR bandpass filter, a wavefront encoding wave-plate, and a sensor. The aspherical lens defines an optical axis and an image side. The IR bandpass filter, the wavefront encoding wave-plate, and the sensor are sequentially arranged (i.e., in that order) at the image side of the aspherical lens, along the optical axis. The sensor is configured for detecting the IR signals sequentially passing through the aspherical lens, the IR bandpass filter and the wavefront encoding wave-plate and is thereby configured for capturing the IR signals. An exemplary IR transmitter/receiver module includes an IR transmitter configured for emitting IR signals and the IR receiver, as above-mentioned.

### BACKGROUND

1. Technical Field

The present invention relates to wireless communication modules, and particularly, to infrared (IR) receivers and infrared transmitter/receiver modules using the same.

2. Description of Related Art

With the rapid development of the wireless communication technologies, wireless electronic devices, such as video game systems having one or more IR transmitter/receiver modules employed therein, are widely used. A typical IR transmitter/receiver module generally includes an IR transmitter and an IR receiver/sensor, such as disclosed in U.S. Pat. Nos. 6,912,379 B2 and 6,585,596 B1, the contents of which are hereby incorporated by reference thereto. The IR transmitter includes an IR emitter configured for emitting IR signals therefrom. The IR receiver is configured for capturing the IR signals and correspondingly producing electronic signals. The electronic signals will be transferred to a game console of the video game system in a certain format as control signals. The IR sensor generally includes one or more spherical lenses and an image sensor, e.g., CMOS (i.e., complementary metal oxide semiconductor), CCD (i.e., charge coupled device), etc. However, a resolution of the conventional IR receiver (generally including optical resolution) is unsatisfactory to meet the higher sensitivity requirements of the wireless electronic devices (e.g., video game systems), due to the physical configuration of the conventional IR receiver.

Therefore, what is needed is to provide an IR receiver with a better resolution and an IR transmitter/receiver module using the same.

### SUMMARY

A preferred embodiment provides an IR receiver configured (i.e., structured and arranged) for capturing IR signals. The IR receiver includes: a sensor, a wavefront encoding wave-plate, an IR bandpass filter, and an aspherical lens. The aspherical lens defines an optical axis and an image side. The IR bandpass filter, the wavefront encoding wave-plate, and the sensor are sequentially arranged (i.e., in that order) at the image side of the aspherical lens, along the optical axis. The sensor is configured (i.e., structured and arranged) for detecting the IR signals passing, in order, through the aspherical lens, the IR bandpass filter, and the wavefront encoding wave-plate, the sensor thereby being configured for capturing the IR signals.

Another preferred embodiment provides an IR transmitter/receiver module. The IR transmitter/receiver module includes an IR transmitter and an IR receiver. The IR transmitter includes at least an IR source configured for emitting IR signals. The IR receiver is configured for capturing the IR signals and includes a sensor, a wavefront encoding wave-plate, an IR bandpass filter, and an aspherical lens. The aspherical lens defines an optical axis and an image side. The IR bandpass filter, the wavefront encoding wave-plate, and the sensor are sequentially arranged at the image side of the aspherical lens, along the optical axis. The sensor is configured for detecting the IR signals passing, in that order, through the aspherical lens, the IR bandpass filter and the wavefront encoding wave-plate, the sensor being capable of thereby capturing the IR signals.

Other advantages and novel features will become more apparent from the following detailed description of embodiments when taken in conjunction with the accompanying drawings.

### BRIEF DESCRIPTION OF THE DRAWINGS

Many aspects of the present IR receiver and IR transmitter/receiver module can be better understood with reference to the following drawings. The components in the drawings are not necessarily drawn to scale, the emphasis instead being placed upon clearly illustrating the principles of the present IR receiver and IR transmitter/receiver module. Moreover, in the drawings, like reference numerals designate corresponding parts throughout the several views.

FIG. 1 is a schematic, cross-sectional view of an IR transmitter/receiver module of a preferred embodiment, showing the IR transmitter/receiver module including an IR transmitter and an IR receiver incorporating a wavefront encoding wave-plate therein; and

FIG. 2 is an enlarged view of the wavefront encoding wave-plate of FIG. 1.

The exemplifications set out herein illustrate various preferred embodiments, in various forms, and such exemplifications are not to be construed as limiting the scope of the present IR receiver and IR transmitter/receiver module in any manner.

### DETAILED DESCRIPTION

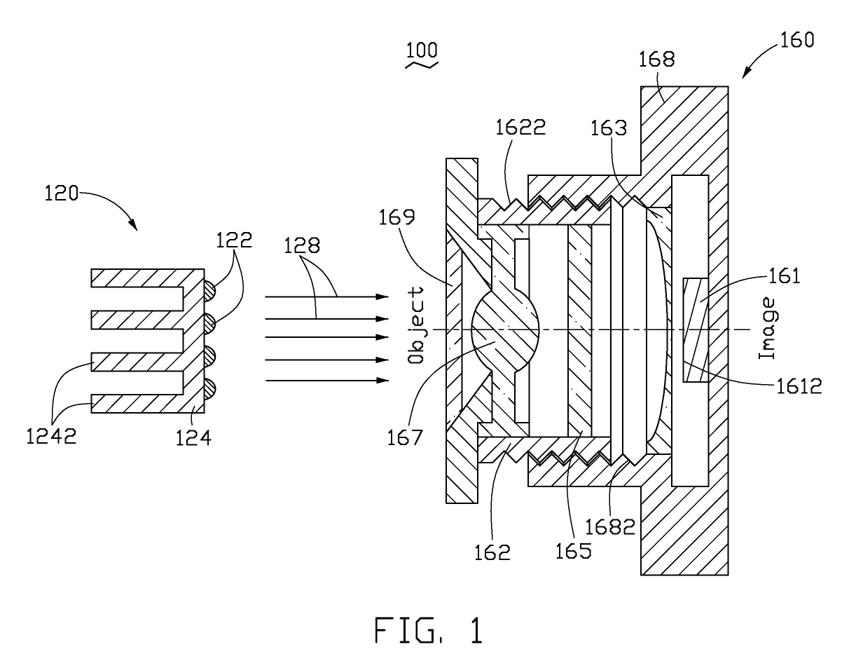

Referring to FIG. 1, an infrared (IR) transmitter/receiver module 100, in associated with a preferred embodiment, is provided. The IR transmitter/receiver module 100 includes an IR transmitter 120 and an IR receiver 160.

The IR transmitter 120 includes at least one IR source 122 and a heat sink 124. Each IR source 122 is configured for emitting IR signals 128 and is thermally connected with the heat sink 124. A thermal interface material (not shown) e.g., silicone, is advantageously interposed at the respective thermal contact surfaces between each corresponding IR source 122 and the heat sink 124. The heat sink 124 generally is made of a thermally conductive material, such as aluminum, copper, or an alloy thereof. The heat sink 124 suitably has a number of heat-dissipating fins 1242 extending therefrom. In the illustrated embodiment, four IR sources 122 are shown. Each of the IR sources 122 is, advantageously, a gallium-aluminum-arsenide (GaAlAs) IR LED. The GaAlAs IR LED could be a bullet-shaped LED or a surface mount LED.

The IR receiver 160 includes a sensor 161, a wavefront encoding wave-plate 163, an IR bandpass filter 165, an aspherical lens 167, a lens barrel 162, and a holder 168. The sensor 161 and the wavefront encoding wave-plate 163 are housed in the holder 168 and mounted directly thereto. The IR bandpass filter 165 and the aspherical lens 167 are secured into the lens barrel 162, in contact therewith. The aspherical lens 167 defines an optical axis (as indicated by the dashed and dotted lines in FIG. 1), which is generally aligned with a central axis of the lens barrel 162. The IR bandpass filter 165, the wavefront encoding wave-plate 163, and the sensor 161 are sequentially located at an image side of the aspherical lens 167, along the optical axis. The lens barrel 162 is threadedly engaged with the holder 168 such that being movable along the optical axis in a rotational manner.

In particular, the sensor 161 defines an imaging-side 1612 and is configured for sensing IR signals passed, in that order, through the aspherical lens 167, the IR bandpass filter 165, and the wavefront encoding wave-plate 163 and then incident thereon. The sensor 161 suitably is a CMOS (i.e., complementary metal oxide semiconductor) or CCD (i.e., charge-coupled device) sensor. The lens barrel 162 generally is cylindrical and defines an external thread formed on a circumferential surface adjacent to the image side of the aspherical lens 167, and the holder 168 defines an internal thread thereon. As such, the lens barrel 162 and the holder 168 can threadedly engage with each other by means of the engagement between the external thread and the internal thread. Preferably, the wavefront encoding wave-plate 163, the IR bandpass filter 165, and the aspherical lens 167 each has a central axis substantially coaxial with the central axis of the lens barrel 162.

The IR bandpass filter 165 suitably has a transmission about 90% for a light ray having a wavelength selected from the range of 900˜1000 nanometers and has a transmission approximately less than 2% for a light ray having a wavelength selected from the ranges of 600˜800 nanometers and 1100˜1200 nanometers. The aspherical lens 167 generally is a converging lens. As an illustration purpose, the IR bandpass filter 165 includes a multi-layer structure. The multi-layer structure includes and, advantageously, is limited to a number of alternately formed titanium dioxide (TiO₂) films and silicon dioxide (SiO₂) films. The total number of the titanium dioxide films and the silicon dioxide films, together, is, usefully, in the approximate range of 30˜50.

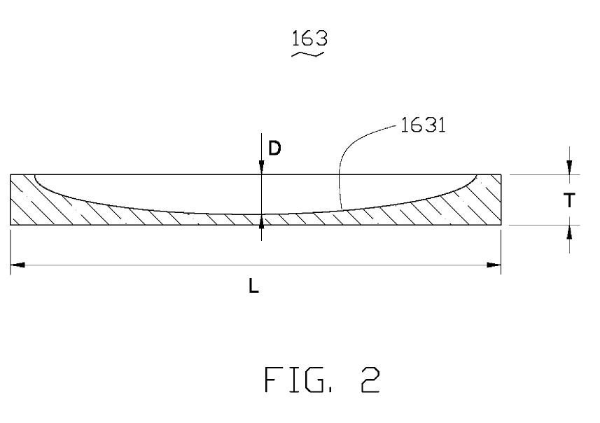

Referring to FIG. 1 and FIG. 2 together, the wavefront encoding wave-plate 163 functions with a wavefront encoding capability and thereby acts as an optical encoder. Once the IR signals 128 pass through the wavefront encoding wave-plate 163, the passed-through IR signals will be encoded. The optically encoded IR signals can thereby be easily and accurately captured by the sensor 161, which facilitates the improvement of the resolution of the IR receiver 160.

In the illustrated embodiment, the wavefront encoding wave-plate 163 is generally plate-shaped and has a depressed portion 1631 defined therein. The depressed portion 1631 is located at a side of the wavefront encoding wave-plate 163 facing away from the imaging-side 1612 of the sensor 161. The depressed portion 1631 suitably has a saddle shape or the like, in cross-section, and is mirror-symmetrical relative to the optical axis. The plate-shaped wavefront encoding wave-plate 163 has a thickness of T and a length of L. The saddle shaped depressed portion 1631 has a maximum depth of D, substantially along the thickness-wise direction of the wavefront encoding wave-plate 163 and at or near the optical axis thereof. A ratio of the D/T (i.e., a ratio of the depth to the thickness) is approximately in the range from 60% to 80%. Preferably, the ratio of the D/T is in the range from 65% to 75%. A ratio of the T/L (i.e., a ratio of the thickness to the length) is approximately in the range from 10% to 40%. Preferably, the ratio of the T/L is in the range from 20% to 35%.

Advantageously, the IR receiver 160 further includes an actuator (not shown) and an IR glass plate 169. The actuator is configured for driving the lens barrel 162 to rotate so as to indirectly move the aspherical lens 167 along the optical axis, thereby auto-focusing the IR receiver 160. The actuator suitably is a voice coil motor, a stepping motor, a piezo-electric actuator, or a micro-electro-mechanical system (also known by the acronym MEMS). The IR glass plate 169 is secured into the lens barrel 162 and is disposed at an object side of the aspherical lens 167 (generally opposite to the image side thereof). Such structure and arrangement of the IR glass plate 169 facilitates the prevention of both visible light and contamination from entering into the lens barrel 162.

In sum, the IR receiver 160, in accordance with the above-mentioned preferred embodiment, can achieve a better resolution, due to the employment of the wavefront encoding wave-plate 163, the IR bandpass filter 165, and the aspherical lens 167 disposed at the image-side 1612 of the sensor 161. It is understood that the IR transmitter/receiver module 100 incorporated the IR receiver 160 also could obtain the advantage of better resolution. Furthermore, the use of the IR transmitter 120 equipped with a heat sink 124 could render the IR transmitter/receiver module 100 to be more stable in operation, due to the faster dissipation of the heat generated from the IR sources 122.

It is indicated that, the IR transmitter/receiver module 100, in accordance with above-mentioned preferred embodiment, can be widely used in wireless electronic devices, such as well-known video game systems or the like, so as to improve the sensitivities of the wireless electronic devices. The IR transmitter 120 and the IR receiver 160 of the IR transmitter/receiver module 100 could be separately installed in different apparatuses or integrally installed in a single apparatus. In one example, the IR transmitter 120 and the IR receiver 160 are separately installed in a controller and a game machine/console, respectively.

In operation, under the control of a game player, the IR transmitter 120 installed in the controller will emit IR signals therefrom. The IR receiver 160 captures the IR signals and generates control signals to execute game commands in response to the IR signals. Advantageously, the IR receiver 160 could send feedback signals to the controller equipped with the IR transmitter 120. In another example, the IR transmitter 120 and the IR receiver 160 are integrally installed in a controller or a game machine, i.e., the controller and the game machine each is equipped with an IR transmitter 120 and an IR receiver 160. The controller and the game machine can exchange information, such as audio data, video data, control data, etc., from each other through respective IR transmitter 120 and IR receiver 160, and thereby game commands can be executed in the game machine during operation.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. An infrared receiver configured for capturing infrared signals, comprising:
an aspherical lens defining an optical axis and an image side;
an infrared bandpass filter;
a wavefront encoding wave-plate; and
a sensor;
wherein the infrared bandpass filter, the wavefront encoding wave-plate, and the sensor are sequentially arranged at the image side of the aspherical lens, along the optical axis, and the sensor is configured for detecting the infrared (IR) signals sequentially passing through the aspherical lens, the infrared bandpass filter, and the wavefront encoding wave-plate, the sensor thereby being configured for capturing the IR signals.

2. The infrared receiver of claim 1, wherein the wavefront encoding wave-plate defines a saddle-shaped depressed portion located at a side thereof facing away from the sensor, the wavefront encoding wave-plate has a length of L and a thickness of T, a ratio of T/L is in the range of 10%˜40%, the depressed portion has a maximum depth D along the thickness-wise direction of the wavefront encoding wave-plate, and a ratio of D/T is in the range of 60%˜80%.

3. The infrared receiver of claim 2, wherein the ratio of T/L is in the range of 20%˜35%, and the ratio of D/T is in the range of 65%˜75%.

4. The infrared receiver of claim 2, wherein the depressed portion is mirror-symmetrical relative to the optical axis.

5. The infrared receiver of claim 2, further comprising a lens barrel and a holder, the lens barrel and the holder being threadedly engaged with each other, the aspherical lens and the infrared bandpass filter being secured into the lens barrel, the wavefront encoding wave-plate and the sensor being housed in the holder.

6. The infrared receiver of claim 5, further comprising an infrared glass plate, the infrared glass plate being secured in the lens barrel and located at an object side of the aspherical lens, the object side of the aspherical lens being opposite to the image side thereof.

7. The infrared receiver of claim 2, wherein the infrared bandpass filter comprises a multi-layer structure including a plurality of alternately formed titanium dioxide films and silicon dioxide films, and the amount of the titanium dioxide films and the silicon dioxide films, in total, is in the range of 30˜50.

8. An infrared transmitter/receiver module, comprising:
an infrared transmitter comprising at least one infrared (IR) source each configured for emitting IR signals; and
an infrared receiver configured for capturing the infrared signals, the infrared receiver comprising:
an aspherical lens defining an optical axis and an image side;
an infrared bandpass filter;
a wavefront encoding wave-plate; and
a sensor;
wherein the infrared bandpass filter, the wavefront encoding wave-plate, and the sensor are sequentially arranged at the image side of the aspherical lens, along the optical axis, and the sensor is configured for detecting the infrared signals sequentially passing through the aspherical lens, the infrared bandpass filter, and the wavefront encoding wave-plate, the sensor thereby being configured for capturing the infrared signals.

9. The infrared transmitter/receiver module of claim 8, wherein the infrared transmitter further comprising a heat sink, the heat sink being thermally connected with said IR source.

10. The infrared transmitter/receiver module of claim 8, wherein at least one said infrared source is a gallium-aluminum-arsenide LED.

11. The infrared transmitter/receiver module of claim 8, wherein the wavefront encoding wave-plate defines a saddle-shaped depressed portion located at a side thereof facing away from the sensor, the wavefront encoding wave-plate has a length of L and a thickness of T, a ratio of T/L is in the range of 10%˜40%, the depressed portion has a maximum depth D along the thickness-wise direction of the wavefront encoding wave-plate, and a ratio of D/T is in the range of 60%˜80%.

12. The infrared transmitter/receiver module of claim 11, wherein the ratio of T/L is in the range of 20%˜35%, and the ratio of D/T is in the range of 65%˜75%.

13. The infrared transmitter/receiver module of claim 11, wherein the depressed portion is mirror-symmetrical relative to the optical axis.

14. The infrared transmitter/receiver module of claim 11, further comprising a lens barrel and a holder, the lens barrel and the holder being threadedly engaged with each other, the aspherical lens and the infrared bandpass filter being secured in the lens barrel, the wavefront encoding wave-plate and the sensor being housed in the holder.

15. The infrared transmitter/receiver module of claim 11, wherein the infrared bandpass filter comprises a multi-layer structure of a plurality of alternately formed titanium dioxide films and silicon dioxide films, and the number of the titanium dioxide films and the silicon dioxide films, in total, is in the approximate range of 30˜50.
